(19) United States
(12) Patent Application Publication
(10) Pub. No.: US 2003/0217699 A1
(43) Pub. Date: Nov. 27, 2003

(54) Feeding trough for domestic animals

(76) Inventor: Jose Ignacio Arruarte Mendizabal, Hondarribia (ES)

Correspondence Address: BROWN & MICHAELS, PC, 400 M & T BANK BUILDING, 118 NORTH TIOGA ST, ITHACA, NY, 14850, US

(21) Appl. No.: 10/440,320

(22) Filed: May 16, 2003

(30) Foreign Application Priority Data
May 24, 2002 (ES) ES U2002201241

(51) Int. Cl. A01K 1/10; A01K 5/00

(52) U.S. Cl. 119/51.5

(57) ABSTRACT

A feeding trough for domestic animals, comprising a solid food hopper (2) which is emptied on a lower tray (4) as the food is consumed, and attached to them a water tank emptying into a drinking trough (5), characterized as said tank (6) slides downwards and rests on a lever similar to scissors (10), whose opposite branch is coupled to a lid (3) placed on the feeding trough (4), such that when the tank (6) is full, it descends from its natural location, opening the lid (3) to permit the animal to eat, whereas when a part of the tank (6) empties into a drinking trough (5), it is lifted again, closing the lid (3) on the feeding trough (4) to prevent the animal from eating.

### BACKGROUND OF THE INVENTION

1. Field of the Invention

The present invention pertains to animal feeding apparatus. More particularly, it pertains to a feeding trough for domestic animals, particularly for dogs or another type of animal which, in normal conditions, eat only once or twice a day, keeping enough water available for them so as to satisfy their thirst.

2. Description of Related Art

Feeding troughs for animals are known consisting of a hopper which empties as the product is consumed, which falls into a lower tray; the drawback posed by this type of feeding troughs is that the amount the animal consumes cannot be controlled, nor the times per day it eats, therefore if this is in reference to dogs, not only does it create bad feeding habits but in anxious animals it can also cause more than a feeding problem.

There are also known feeding troughs for animals that present a drive by means of a motor or another electrically driven device.

### SUMMARY OF THE INVENTION

The feeding trough described here favorably solves this drawback, since the times per day the animal eats can be programmed, as well as the duration each meal is available to the animal. Thus the amount of food is controlled. Its operation is not affected by a cut in electrical service.

To do so, it uses a very simple system carrying out the opening of the feeding trough while a water tank is filled which will be used for the animal's consumption. This water tank slides downwards and rests on a part similar to scissors, whose opposite branch is connected to a lid placed on the feeding trough. When the tank is fill, it descends, opening the lid and permitting the animal to eat.

The tank has a programmable valve which empties the water into the lower drinking trough. By controlling the flow rate of this valve, the time it takes the water to be emptied from the tank in the drinking trough is controlled, and as a result, the time the feeding trough is open. When the weight of the tank decreases, it rises, closing the lid until the established programming carries out a new tank filling period, at which instant the opening process of the feeding trough lid is repeated.

### BRIEF DESCRIPTION OF THE DRAWING

FIG. 1 shows a general and perspective view of a feeding trough for animals carried out according to this invention.

FIG. 2a shows a right side view of the invention.

FIG. 2b shows a front view of the invention.

FIG. 2c shows a left side view of the invention.

FIG. 2d shows a top view of the invention, with the cover open.

FIGS. 3 and 4 represent a vertical section of this feeding trough along the line 3/4-3/4 in FIG. 2b, when the lid (3) is closed or open respectively.

### DETAILED DESCRIPTION OF THE INVENTION

This feeding trough comprises a hopper compartment (2) filled with the animal's food, which, by its own weight, descends and fills a lower tray (4), covered by a lid (3). When the lid (3) is open, the food can be removed from the front of the tray (4).

Attached to this solid food area formed by the hopper (2) and feeding trough (4) there is a water tank (6), which empties into a lower tray (5) in a controlled manner by means of a valve (8).

This tank (6) slides downwards into an equally shaped cavity and rests on a lever formed like scissors (10), whose other branch is coupled to the lid (3) of the feeding trough (4). When the tank (6) is filled, it descends under the weight of the water, causing the lid (3) to open and allowing the animal to take advantage of that moment to eat.

When a predetermined amount of water has been released from the tank (6) to the drinking trough (5) and the latter loses weight as a result, it moves upwards again, thereby closing the lid (3) on the feeding trough (4).

As mentioned, emptying the water from the tank (6) to the drinking trough (5) is controlled by a valve (8), the regulation thereof achieves controlling the time it takes to empty and, as a result, the time the lid (3) is open.

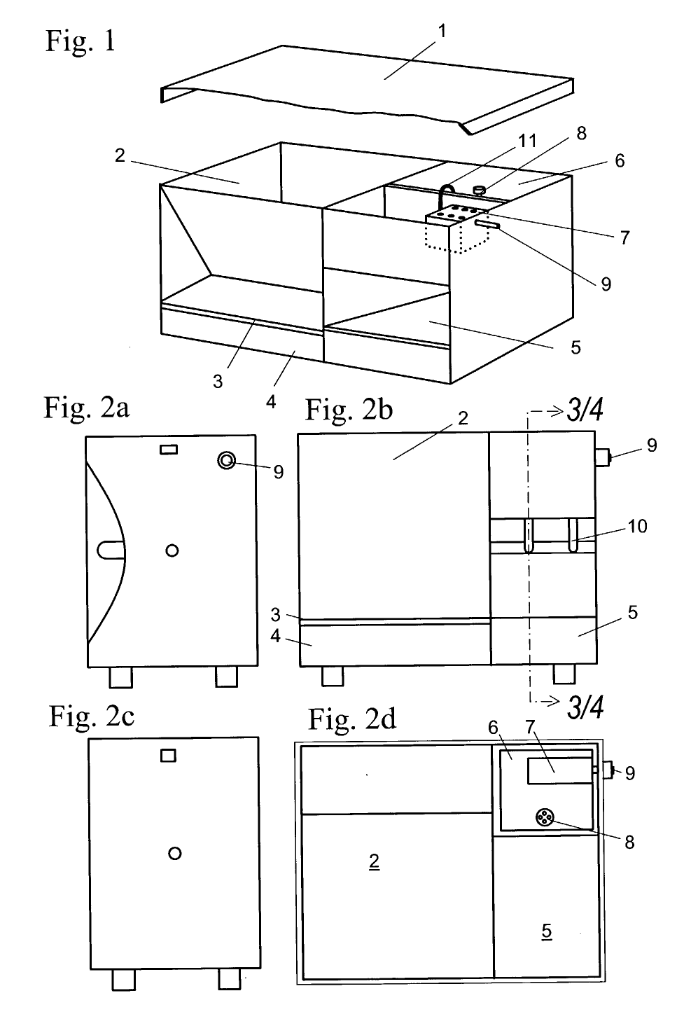

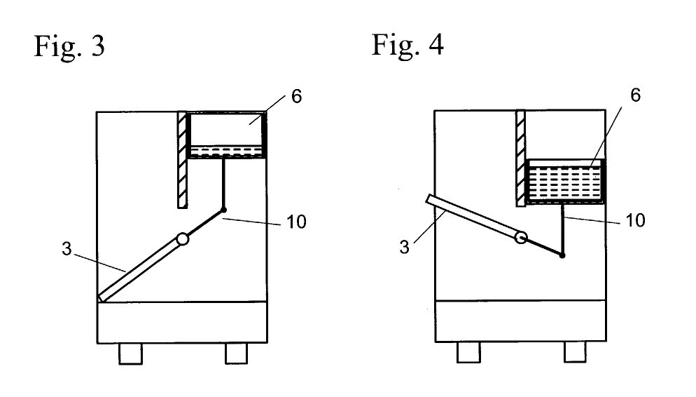

A programmer (7) fed by a battery is placed between the water inlet (9) and the tank (6), limiting the entry of water to determined periods of the day. Thus a daily eating order is established, such that the animal always has water in the drinking trough (5) but only has solid food at those programmed periods of the day and while said recipient (6) is filled and is in its most sunken position within the cavity defined in the apparatus of the present invention. The programmer (7) may be located in front of the tank (6), feeding water into the tank (7) by a hose (11) as shown in FIG. 1, or the programmer (7) may be located over the tank (6) as shown in FIGS. 2a-2d.

The assembly is closed with an upper cover (1), either hinged or fitted on, which can be provided with safety closure means so that the animal cannot access the inside containing the food or mechanisms.

It is not deemed necessary to extend this description so that any skilled person in the art may understand the scope of the invention and the advantages derived thereof. The terms in which this specification has been written must always be taken in a broad and non-limiting sense. The materials, shape and arrangement of the elements will be susceptible to variation as long as it implies no alteration of the essential features of the invention, which are claimed below.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A feeding trough for domestic animals, comprising a solid food hopper (2) which is emptied on a lower tray (4) as food is consumed, and attached to them a water tank emptying into a drinking trough (5), characterized as said tank (6) slides downwards and rests on a lever similar to scissors (10), whose opposite branch is coupled to a lid (3) placed on the feeding trough (4), such that when the tank (6) is full, it descends from its natural location, opening the lid (3) to permit the animal to eat, whereas when a part of the tank (6) empties into a drinking trough (5), it is lifted again, closing the lid (3) on the feeding trough (4) to prevent the animal from eating.

2. A feeding trough for domestic animals according to claim 1, characterized in that a programmer (7) fed by a battery is placed between the tank (6) and the water inlet (9), limiting the entry of water at determined periods of the day so as to thus establish a daily eating order.

3. A feeding trough for domestic animals according to claim 1, characterized in that the emptying of the water from the tank (6) to the drinking trough (5) is controlled by a valve, the regulation thereof controls the time it takes the tank to empty and, as a result, the time the lid (3) is open.
